(19) United States
(12) Patent Application Publication
(10) Pub. No.: US 2022/0082399 A1
(43) Pub. Date: Mar. 17, 2022

(54) VEHICLE AND METHOD OF CONTROLLING THE SAME

(71) Applicants: HYUNDAI MOTOR COMPANY, Seoul (KR); KIA CORPORATION, Seoul (KR)

(72) Inventor: Seunghwan Lee, Suwon-si (KR)

(21) Appl. No.: 17/328,579

(22) Filed: May 24, 2021

(30) Foreign Application Priority Data
Sep. 14, 2020 (KR) 10-2020-0117571

(51) Int. Cl. G01C 21/36; G01C 21/34

(52) U.S. Cl. CPC G01C 21/362; G01C 21/3476; G01C 21/3611

(57) ABSTRACT

A vehicle may include a communication device; an output device; and a control device electrically connected to the communication device and the output device. The control device may be configured to receive a control signal for controlling at least one operation of the output device from a server through the communication device according to at least one of a position of the vehicle, communication with an external device of the vehicle, and a current time, and to control the at least one operation of the output device according to the control signal.

### CROSS-REFERENCE TO RELATED APPLICATION(S)

The present application claims priority to Korean Patent Application No. 10-2020-0117571, filed on Sep. 14, 2020, the entire contents of which is incorporated herein for all purposes by this reference.

### BACKGROUND OF THE INVENTION

### Field of the Invention

The present invention relates to a vehicle and a method of controlling the vehicle.

### Description of Related Art

Conventionally, various service providers have developed and provided products so that passengers of vehicles can shop, watch movies, and camp with the vehicles.

For example, drive-through refers to a store in which a driver can shop while in the vehicle. Conventionally, when the passenger of the vehicle purchases food such as coffee and hamburgers through the drive-through and eats, the sensory experience which may be experienced at an original store was not possible. For example, while the driver of the vehicle was purchasing and/or eating food through the drive-through, it was not possible to receive music and lighting provided in the store.

In a case of watching a movie using the vehicle in a drive-in theater, there are disadvantages that manual operation of the vehicle, such as directly tuning a radio frequency, turning off headlamps, and operating a side brake to turn off a daytime running light (DRL) which may interfere with viewing by the passenger of the vehicle, is required. Furthermore, in some cases, the vehicle may cause discomfort in watching the movie by the passenger due to an operation such as outputting a warning message in relation to a vehicle's power supply or idling.

The information included in this Background of the present invention section is only for enhancement of understanding of the general background of the present invention and may not be taken as an acknowledgement or any form of suggestion that this information forms the prior art already known to a person skilled in the art.

### BRIEF SUMMARY

Various aspects of the present invention are directed to providing a vehicle configured for automatically receiving an experience felt at a store of a specific service provider or a vehicle setting optimized for a service when passengers of the vehicle receive the service from the specific service provider using the vehicle, and a method of controlling the vehicle.

For example, when the passenger selects a specific service of the specific service provider, some conditional services (service related to a specific time, specific condition and/or convenience-related function) related to a function of the vehicle provided by the specific service provider are provided, enhancing the user experience so that passengers can experience at the store.

For example, the vehicle may automate various vehicle functions linked to external services according to a service request and flexibly provide the vehicle functions to the passengers.

Additional aspects of the present invention will be set forth in part in the description which follows, and in part, will be obvious from the description, or may be learned by practice of the present invention.

According to various aspects of the present invention, there is provided a vehicle including: a communication device; an output device; and a control device electrically connected to the communication device and the output device. The control device may be configured to receive a control signal for controlling at least one operation of the output device from a server through the communication device according to at least one of a position of the vehicle, communication with an external device of the vehicle, and a current time, and to control the at least one operation of the output device according to the control signal.

The control device may be configured to transmit a service request signal to the server through the communication device according to at least one of the position of the vehicle, the communication with the external device of the vehicle, and the current time, and to receive the control signal through the communication device in a response to the transmission of the service request signal.

The control device may be configured to receive the control signal through the communication device according to a communication connection with the server.

The vehicle may further include a navigation device. The control device may be configured to receive the control signal from the server on the basis that the position of the vehicle is a position corresponding to a predetermined reference distance to a destination or a stopover set by the navigation device.

The vehicle may further include a navigation device. The control device may be configured to receive the control signal from the server on the basis that the current time corresponds to a predetermined reference time required with an expected arrival time to a destination or a stopover set by the navigation device.

The vehicle may further include a navigation device. The control device may be configured to receive the control signal from the server in a response to an end of a route guidance of the navigation device according to the position of the vehicle being a destination or a stopover set by the navigation device of the vehicle.

The control device may be configured to receive the control signal from the server based on communication with the external device configured for at least one of order and payment.

The vehicle may further include a navigation device. Based on at least one of the order and the payment, the control device may be configured to control the navigation device to guide the vehicle to a route including a service provider related to the at least one of the order and the payment.

The control device may be configured to receive the control signal from the server according to the position of the vehicle being a predetermined place related to the server.

The control device may be configured to receive the control signal from the server based on the vehicle being stopped.

The output device may include a speaker. The control device may be configured to control the speaker to output a sound included in the control signal.

The output device may include at least one lighting device. The control device may be configured to control the at least one lighting device to output light of brightness and color corresponding to lighting information according to the lighting information included in the control signal.

The output device may include a display device. The control device may be configured to control the display device to provide visual information corresponding to service information according to the service information included in the control signal.

The output device may include a speaker. The control device may be configured to set a radio frequency of the vehicle and control a volume of the speaker according to radio frequency information and volume information related to the speaker included in the control signal.

The output device may include at least one of a speaker or the display device. The control device may be configured to control the at least one output device to output information for guiding a parking area and information for recommending seat setting of the vehicle according to the information for guiding the parking area of the vehicle and the information for recommending seat setting of the vehicle included in the control signal.

According to various aspects of the present invention, there is provided a method of controlling a vehicle including: receiving, by a control device, a control signal for controlling at least one operation of an output device from a server through a communication device according to at least one of a position of the vehicle, communication with an external device of the vehicle, and a current time; and controlling, by the control device, the at least one operation of the output device according to the control signal.

The controlling of the at least one operation may include controlling a speaker included in the output device to output a sound included in the control signal.

The controlling of the at least one operation may include controlling at least one lighting device included in the output device to output light of brightness and color corresponding to lighting information according to the lighting information included in the control signal.

The controlling of the at least one operation may include controlling a display device included in the output device to provide visual information corresponding to service information according to the service information included in the control signal.

The controlling of the at least one operation may include setting a radio frequency of the vehicle and controlling a volume of the speaker according to radio frequency information included in the control signal and volume information related to a speaker included in the output device. Furthermore, the controlling of the at least one operation may include controlling not only the radio frequency of the vehicle but also various media. For example, the controlling of the at least one operation may include media entering a specific streaming mode and setting a corresponding service channel.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram of a system including a server and a vehicle according to various exemplary embodiments of the present invention.

FIG. 2 is a flowchart illustrating an operation of a vehicle according to various exemplary embodiments of the present invention.

FIG. 3 is a flowchart illustrating an operation of a system including a server and a vehicle according to various exemplary embodiments of the present invention.

FIG. 4 is a flowchart illustrating an operation of a system including a server and a vehicle according to various exemplary embodiments of the present invention.

FIG. 5 is a view for describing an operation of a vehicle according to various exemplary embodiments of the present invention.

FIG. 6 is a view for describing an operation of a vehicle according to various exemplary embodiments of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Like reference numerals refer to like elements throughout the specification. Not all elements of the exemplary embodiments of the present invention will be described, and the description of what are commonly known in the art or what overlap each other in the exemplary embodiments will be omitted. The terms as used throughout the specification, such as “˜part,” “˜module,” “˜member,” “˜block,” etc., may be implemented in software and/or hardware, and a plurality of “˜parts,” “˜modules,” “˜members,” or “˜blocks” may be implemented in a single element, or a single “˜part,” “˜module,” “˜member,” or “˜block” may include a plurality of elements.

It will be further understood that the term “connect” and its derivatives refer both to direct and indirect connection, and the indirect connection includes a connection over a wireless communication network.

The terms “include (or including)” and “comprise (or comprising)” are inclusive or open-ended and do not exclude additional, unrecited elements or method steps, unless otherwise mentioned.

It will be understood that, although the terms first, second, third, etc., may be used herein to describe various elements, components, regions, layers and/or sections, these elements, components, regions, layers and/or sections may not be limited by these terms. These terms are only used to distinguish one element, component, region, layer or section from another region, layer or section.

It is to be understood that the singular forms “a,” “an,” and “the” include plural references unless the context clearly dictates otherwise.

Reference numerals used for method steps are merely used for convenience of explanation, but not to limit an order of the steps. Thus, unless the context clearly dictates otherwise, the written order may be practiced otherwise.

Hereinafter, an operation principle and embodiments of the present invention will be described with reference to accompanying drawings.

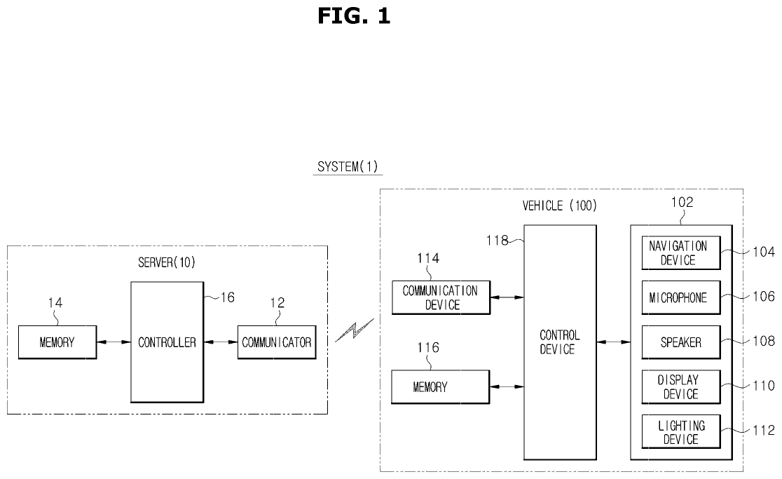

FIG. 1 is a block diagram of a system including a server and a vehicle according to various exemplary embodiments of the present invention.

Referring to FIG. 1, a server 10 may include a communicator 12, a memory 14 and/or a controller 16.

The communicator 12 (or also referred to as a communication circuit) may support establishing a wired communication channel between the server 10 and an external device, for example, a vehicle 100 and performing communication through the established communication channel. For example, the communicator 12 may include a wireless communication module (e.g., a cellular communication module, a Wi-Fi communication module, a short-range wireless communication module, or a global navigation satellite system (GNSS) communication module) to communicate with the external device. The communication module 12 may include the communication circuit.

The memory 14 may store a variety of data used by at least one component (the communicator 12 and/or the controller 16) of the server 10, for example, input data or output data for a software program and instructions related thereto. The memory 14 may include a volatile memory and/or a non-volatile memory.

The memory 14 may store information for controlling at least one component of the vehicle 100 upon communication connection with the vehicle 100.

For example, the information for controlling at least one component of the vehicle 100 may include information configured for controlling a speaker 108 of the vehicle 100. The information configured for controlling the speaker 108 may include volume information related to the speaker 108 and/or sound which may be output through the speaker 108.

For example, the information for controlling at least one component of the vehicle 100 may include lighting information configured for controlling at least one lighting device 112 of the vehicle 100. The lighting information configured for controlling at least one lighting device 112 may include information related to a lighting device to be controlled and/or information for controlling a brightness and a color of a lighting device to be controlled among at least one lighting device 112.

For example, the information for controlling at least one component of the vehicle 100 may include information configured for controlling a display device 110 of the vehicle 100. The information configured for controlling the display device 110 may include service information which may be output through the display device 110 of the vehicle 100.

For example, the information for controlling at least one component of the vehicle 100 may include radio frequency information to be provided to the vehicle 100.

For example, the information for controlling at least one component of the vehicle 100 may include visual or audible information for guiding a parking area of the vehicle 100 and visual or audible information for recommending a seat setting of the vehicle 100.

The controller 16 (also referred to as a control circuit or processor) may control at least one other component of the connected server 10 (e.g., a hardware component (e.g., (the communicator 12 and/or the memory 14)) or a software component (software program)), and may perform various data processing and operations. The controller 16 may include the processor and the memory.

The controller 16 may transmit a control signal corresponding to information for controlling the at least one component of the vehicle 100 stored in the memory 14 to the vehicle 100 based on the communication connection with the vehicle 100 through the communicator 12.

The server 10 may include a server of a service provider that has made business cooperation with a manufacturer of the vehicle 100. For example, the server 10 may include the server of the service provider that provides services such as shopping, watching movies, or camping using the vehicle 100. The server 10 may be selected by the vehicle 100 according to the communication connection with the vehicle 100 or a driving route of the vehicle 100.

The vehicle 100 may include an input/output device 102, a communication device 114, a memory 116, and/or a control device 118.

The input/output device 102 may include a navigation device 104, a microphone 106, the speaker 108, the display device 110 and/or the lighting device 112.

The navigation device 104 may output navigation information. The navigation information may include route information providing a route to a destination received from a driver of the vehicle 100.

The navigation device 104 may generate the route information by matching position coordinates of the vehicle 100 identified through a satellite signal on a map previously stored in the memory 116 to identify vehicle position information and driving environment information, etc. For example, the navigation device 104 may include a Global Positioning System (GPS) and receive the satellite signal propagating from a GPS satellite through the GPS. The satellite signal may include the vehicle's position coordinates.

The microphone 106 may receive sound, for example, a voice of the passenger of the vehicle 100, and may change the received sound into an electrical signal.

The speaker 108 may convert the electrical signal into the sound and output it.

The display device 110 may display, for example, various types of content (e.g., text, images, videos, icons, and/or symbols). The display device 110 may include a touch screen, and may receive, for example, a touch, gesture, proximity, or hovering input using a part of a user's body.

The above-described navigation device 104 and display device 110 may be included in an audio video navigation (AVN) device of the vehicle 100. The AVN device may refer to a multimedia device in which audio, video, navigation, or a telematics terminal are integrated into one. The AVN device may be provided on a center fascia of the vehicle 100, but is not limited thereto.

The lighting device 112 may be one or more, and may include lighting devices at various positions indoors and/or outdoors of the vehicle 100. For example, the lighting device 112 may be provided on a ceiling of an interior of the vehicle 100, an internal sun visor, a headrest of a driver's seat and an auxiliary seat, a door of the vehicle 100, and the like. Furthermore, the lighting device 112 may be provided at a position such as a dashboard, a windshield, or a seat.

The lighting device 112 may include a lamp, a luminescent emitted diode (LED), or the like. Furthermore, the lighting device 112 may emit light of various colors such as red (R), green (G), blue (B), and white (W).

The communication device 114 may support establishing the wired or wireless communication channel between the vehicle 100 and the external device, for example, the server 10 and performing communication through the established communication channel, and may include the communication circuit. For example, the communication device 114 may include the wireless communication module (e.g., the cellular communication module, the Wi-Fi communication module, the short-range wireless communication module, or the global navigation satellite system (GNSS) communication module) and/or a wired communication module. The communication device 114 may communicate with the external device using a corresponding communication module among them. For example, the short-range wireless communication module may include a Bluetooth communication module.

The memory 116 may store the variety of data used by at least one component (input/output device 102, communication device 114 and/or control device 118) of vehicle 100, for example, input data or output data for the software program and instructions related thereto. The memory 116 may include the volatile memory and/or the non-volatile memory.

The control device 118 (also referred to as the control circuit or processor) may control at least one other component of the vehicle 100 (e.g., the hardware component (e.g., input/output device 102, communication device 114 and/or the memory 116)) or the software component (software program)), and may perform various data processing and operations. The control device 118 may include an electronic control unit (ECU) that controls a power system of the vehicle 100. The control device 118 may include the processor and the memory.

The control device 118 may receive a control signal for controlling at least one operation of the vehicle 100 from the server 10 through the communication device 114 based on at least one of the position of the vehicle 100, communication with the external device of the vehicle 100, and a current time. The control device 118 may control at least one operation of the vehicle 100 based on the control signal received from the server 10.

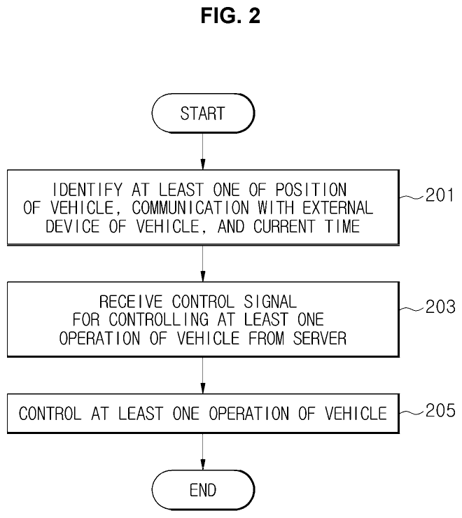

Hereinafter, the operation of the control device 118 will be described in detail with reference to FIGS. 2 to 6.

Meanwhile, although not illustrated in FIG. 1, the vehicle 100 may further include an in car payment system (ICPS). The ICPS allows payment to be made through a payment process between the vehicle 100 and an affiliated store and/or a card company through wireless communication through the communication device 114. For example, the ICPS may be included in the AVN device of the vehicle 100.

Furthermore, the speaker 108, the display device 110, the lighting device 112, the audio of the AVN device and/or the video of the AVN device in the above-described embodiment of FIG. 1 may be referred to an output device of the vehicle 100.

FIG. 2 is a flowchart illustrating the operation of the vehicle 100 (or the control device 118 of the vehicle 100) according to various exemplary embodiments of the present invention.

The vehicle 100 may identify at least one of the position of the vehicle 100, communication with the external device of the vehicle 100, and the current time (201).

The vehicle 100 may identify the position of the vehicle 100 based on an output signal of the GPS.

The vehicle 100 may identify whether or not to communicate with the external device through the communication device 114.

The external device may include the server that receives payment information from the server 10 or the ICPS of the vehicle 100 and performs payment.

The vehicle 100 may receive the control signal for controlling at least one operation of the vehicle 100 from the server 10 based on at least one of the position of the vehicle 100, the communication with the external device of the vehicle 100, and the current time (203).

The vehicle 100 may receive a control signal from the server 10 on the basis that the position of the vehicle 100 is a position corresponding to a predetermined reference distance from the destination or a stopover set by the navigation device 104.

The vehicle 100 may receive a control signal from the server 10 based on the current time corresponding to a predetermined reference time required to arrive at the destination or the stopover set by the navigation device 104.

For example, when the current time corresponds to the predetermined reference time required, it may refer to that the current time remains until a predetermined time period required to arrive to the destination or the stopover set by the navigation device 104 by the predetermined reference time required.

The vehicle 100 may receive a control signal from the server 10 in a response to an end of a route guidance of the navigation device 104 based on the position of the vehicle 100 being the destination or the stopover set by the navigation device 104.

The vehicle 100 may receive a control signal from the server 10 based on communication with the external device configured for at least one of ordering and payment.

For example, the vehicle 100 may receive a control signal from the server 10 based on communication with the server 10 for an order (e.g., food order) for any one service. As various exemplary embodiments of the present invention, the vehicle 100 may receive a control signal from the server 10 based on communication with a payment related server for payment through the ICPS of the vehicle 100.

The vehicle 100 may receive a control signal from the server 10 based on the fact that the position of the vehicle 100 is a predetermined place related to the server 10.

The vehicle 100 may control at least one operation of the vehicle 100 based on the control signal received from the server 10 (205).

The vehicle 100 may control the speaker 108 to output sound included in the control signal.

The vehicle 100 may control the lighting device 112 to output light of brightness and/or color corresponding to the lighting information based on lighting information included in the control signal.

The vehicle 100 may control the display device 110 to provide visual information corresponding to the service information based on service information included in the control signal.

The vehicle 100 may set the radio frequency of the vehicle 100 and/or control the volume of the speaker 108 based on the radio frequency information and/or the volume information related to the speaker 108 included in the control signal.

The vehicle 100 may control the speaker 108 and/or the display device 110 to output information guiding the parking area of the vehicle 100 included in the control signal and/or seat setting recommendation information related to the vehicle 100 based on the information guiding the parking area of the vehicle 100 included in the control signal and/or the seat setting recommendation information related to the vehicle 100.

According to the exemplary embodiment of FIG. 2 described above, when the passengers are on the vehicle 100 and receive the services at a service provider's store that provides services such as shopping, watching movies, or camping, the vehicle 100 may operate some functions by receiving the control signal from the server 10 related to the store so that the passengers may experience an atmosphere similar to that of the store.

For example, when the vehicle 100 selects a store of the service provider as the destination or the stopover of the navigation device 100 to receive the service, the vehicle 100 may receive a control signal associated with the function of the vehicle 100 from the server 10 related to the store. Alternatively, when the vehicle 100 makes a service request through the input/output device 102, etc., the vehicle 100 may receive the control signal associated with the function of the vehicle 100 from the server 10 related to the store.

For example, the control signal received from the server 10 is for providing a function to allow the passengers in the vehicle 100 to experience the service similar to that of the store in the vehicle 100, and may be related to the atmosphere of the vehicle 100 and/or the convenience of the passengers.

For example, when the passengers of the vehicle 100 use the service of any one store within the vehicle 100, according to the above-described embodiment, the passengers may experience music and/or lighting services provided by stores that changes according to time, weather, and account.

For example, when the vehicle 100 sets the destination of the navigation device 104 as a drive-through of the store and then the vehicle 100 arrives at the destination, according to the above-described embodiment, the vehicle 100 may receive the service provided by the server 10 related to the drive-through.

For example, when the vehicle 100 communicates with the server 10 at a specific point such as a high pass gate, the vehicle 100 may receive a service provided by the server 10.

Meanwhile, in the above-described operation, the reception of the control signal of the vehicle 100 in operation 203 may be operated by, for example, the server 10 transmitting the control signal based on a request of the vehicle 100. As various exemplary embodiments of the present invention, in the reception of the control signal of the vehicle 100 in operation 203 may be performed by the server 10 transmitting the control signal based on the identification of the server 10 for communication connection with the vehicle 100 and/or the server 10 identifying that the vehicle 100 has entered a designated area of the server 10.

In addition to the above-described embodiment, the vehicle 100 may set a mode of the vehicle 100 as a first mode in which the service from the server 10 is provided based on at least one of the position of the vehicle 100, communication with the external device, and the current time. The vehicle 100 may control the speaker 108 and/or the display device 110 to output information notifying the setting of the first mode. The vehicle 100 may perform operation 203 described above based on the setting of the first mode.

For example, the first mode may include a cafe mode, a travel mode, a drive-in theater mode, a hamburger shop mode, or a club mode, depending on the server 10.

Furthermore, in addition to the above-described embodiment, the vehicle 100 may receive the control signal from the server 10 further based on the vehicle 100 stops, that is, at least one of the position of the vehicle 100, communication with the external device of the vehicle 100, and the current time, and the vehicle 100 stops.

For example, the control signal may be received from the server 10 based on the position of the vehicle 100 being the predetermined place related to the server 10 and the vehicle 100 being stopped.

Furthermore, in addition to the above-described embodiments, the termination condition of controlling at least one operation of the vehicle 100 may vary, such as changing the position, time, and/or mode of the vehicle 100. The termination condition for controlling at least one operation of the vehicle 100 may be stored in advance in the memory 14 of the server 10 or the memory 116 of the vehicle 100.

For example, the vehicle 100 may terminate the control of at least one operation of the vehicle 100 according to the control signal of the server 10 based on the termination condition included in the control signal of the server 10 or the termination condition stored in the memory 116.

For example, the termination condition of at least one operation control of the vehicle 100 may include a point in time after the predetermined time period elapses after the vehicle 100 starts to receive the service (for example, after pick up of the beverage) at the moment when the vehicle 100 leaves a predetermined area (or also referred to as a zone or place), the vehicle 100 enters another mode, and/or a user input.

Furthermore, in addition to the above-described embodiment, the vehicle 100 may only allow control of the operation of the vehicle 100 identified as safe for a control signal from the server 10.

For example, the memory 116 of the vehicle 100 may store information related to the operation which may be controlled by the external device, for example, the server 10, or information related to the operation that cannot be controlled by the external device. Accordingly, the vehicle 100 may identify whether the control signal from the server 10 is safe based on the information stored in the memory 116.

Furthermore, in addition to the above-described embodiment, it is possible to control the operation of the vehicle 100 only for the control signal of the server 10 previously negotiated for each manufacturer of the vehicle 100 and the state information related to the vehicle 100.

For example, when it is previously negotiated to control only the lighting device 112 and the speaker 108 of the vehicle 100, even if the control signal of the server 10 includes the signal related to power control or driving mode control of the vehicle 100, the vehicle may prevent the vehicle 100 from performing the power control and the driving mode control of the vehicle 100 based on the control signal.

Furthermore, in addition to the above-described embodiment, the vehicle 100 may not allow the vehicle 100 to control the operation of the vehicle 100 with respect to the control signal of the server 10 based on the state information related to the vehicle 100.

For example, when using the service of the server 10 of the service provider that provides services such as watching movies or camping, the vehicle 100 may not allow the control of the vehicle 100 based on some control signals of the server 10.

For example, the vehicle 100 using the service of the server 10 of the service provider, such as watching movies or camping may prevent discharge of the vehicle 100 in advance by monitoring and controlling the lighting device 112 and the power state of the vehicle 100 only when the vehicle 100 is stopped. Accordingly, even if the control signal of the server 10 includes the control signal related to entering and/or driving to a specific position of the vehicle 100, it is possible to prevent the vehicle 100 from performing control related to the entry and/or driving to the specific position of the vehicle 100 based on the control signal.

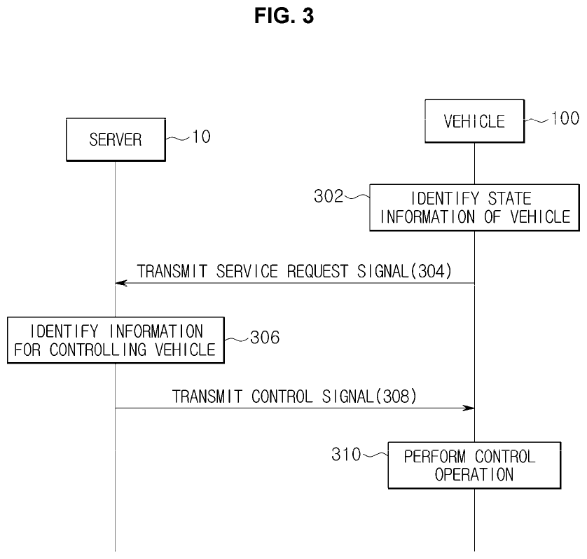

FIG. 3 is a flowchart illustrating an operation of a system including a server and a vehicle according to various exemplary embodiments of the present invention.

The vehicle 100 (or the control device 118 of the vehicle 100) may identify the state information related to the vehicle 100 (302).

The state information related to the vehicle 100 may include the position of the vehicle 100, communication with the external device of the vehicle 100, whether the vehicle 100 stops, and/or the current time.

The vehicle 100 may transmit a service request signal to the server 10 based on the state information related to the vehicle 100 (304).

The vehicle 100 may transmit the service request signal through the communication device 114 on the basis that the position of the vehicle 100 is the position corresponding to the predetermined reference distance from the destination or the stopover set by the navigation device 104.

For example, the position corresponding to the predetermined reference distance from the destination or the stopover in which the position of the vehicle 100 is set may refer to that the distance between the vehicle 100 and the destination or the stopover remains as much as the predetermined reference distance.

For example, the predetermined reference distance may be 0, and the vehicle 100 may transmit the service request signal to the server 10 based on arrival at the destination or the stopover.

The vehicle 100 may transmit the service request signal to the server 10 in a response to the end of the route guidance of the navigation device 104 based on the position of the vehicle 100 being the destination or the stopover set by the navigation device 104.

The vehicle 100 may transmit the service request signal to the server 10 based on the current time corresponding to the predetermined reference time required to arrive at the destination or the stopover set by the navigation device 104.

For example, when the current time corresponds to the predetermined reference time required, it may refer to that the current time remains until the expected arrival time to the destination or the stopover set by the navigation device 104 by the predetermined reference time required.

The vehicle 100 may transmit the service request signal to the server 10 based on communication with the external device configured for at least one of ordering and payment.

For example, the vehicle 100 may transmit the service request signal to the server 10 based on communication with the server 10 for ordering the service. As various exemplary embodiments of the present invention, the vehicle 100 may transmit the service request signal to the server 10 based on communication with a payment-related server for payment through ICPS of the vehicle 100.

The server 10 (or the controller 16 of the server 10) may identify information for controlling the vehicle 100 in a response to receiving the service request signal (306).

The server 10 may receive the service request signal through the communicator 12.

The information for controlling the vehicle 100 may include information for controlling at least one component of the vehicle 100, and may be information stored in the memory 14.

For example, the information for controlling the vehicle 100 may include information for implementing the atmosphere and/or theme of the service provider related to the server 10 visited by the vehicle 100 in the vehicle 100 as well.

The information for controlling the at least one component of the vehicle 100 may include information configured for controlling the speaker 108 of the vehicle 100. The information configured for controlling the speaker 108 may include volume information related to the speaker 108 and/or sound which may be output through the speaker 108.

The information for controlling the at least one component of the vehicle 100 may include lighting information configured for controlling at least one lighting device 112 of the vehicle 100. The lighting information configured for controlling at least one lighting device 112 may include the information related to the lighting device to be controlled and/or information for controlling a brightness and the color of the lighting device to be controlled among at least one lighting device 112.

The information for controlling the at least one component of the vehicle 100 may include information configured for controlling a display device 110 of the vehicle 100. The information configured for controlling the display device 110 may include the service information which may be output through the display device 110 of the vehicle 100.

For example, the service information may be in various combinations according to a space and/or a service concept desired to be provided from the server 10 to the vehicle 100. The vehicle 100 may perform the operation corresponding to the user input upon receiving the user input (also referred to as a physical manipulation) such as the user's touch input for service information output through the display device 100.

The information for controlling the at least one component of the vehicle 100 may include radio frequency information to be provided to the vehicle 100.

The information for controlling the at least one component of the vehicle 100 may include visual or audible information for guiding the parking area of the vehicle 100 and visual or audible information for recommending the seat setting of the vehicle 100

The server 10 may transmit the control signal corresponding to information for controlling the vehicle 100 to the vehicle 100 (308).

The server 10 may transmit the control signal to the vehicle 100 through the communicator 12.

The vehicle 100 may perform the control operation based on the reception of the control signal (310).

The vehicle 100 may receive the control signal through the communication device 114, and may perform the control operation by identifying information for controlling the vehicle 100 included in the control signal.

Detailed embodiments of the control operation have been described in detail in operation 205, and thus will be omitted.

According to the above-described embodiment of FIG. 3, when the state information related to the vehicle 100 satisfies a predetermined operation condition, the vehicle 100 may transmit the service request signal to the server 10 so that the control operation of the vehicle 100 by the server 10 is performed.

Meanwhile, in addition to the above-described embodiment, when the vehicle 100 transmits the service request signal including order information to the server 10 based on communication with the server 10 for ordering any one service, the vehicle 100 may additionally control the navigation device 104.

For example, the vehicle 100 may output visual information corresponding to service information related to a specific cafe through an output device such as the display device 110 based on reception of the user input. Time information corresponding to the service information related to the specific cafe may include an order, a cafe event guidance, and the like.

Furthermore, the vehicle 100 may submit the order according to the user input through the communication device 114 to the server 10 of the specific cafe. For example, the vehicle 100 may receive an order input “I will buy coffee at the specific cafe” from the user through the input device such as the microphone 106, and the vehicle 100 may communicate with the server 10 for the order.

The vehicle 100 may additionally control the navigation device 104 based on the vehicle 100 communicating with the server 10 for ordering to set the stopover or route guidance to the specific cafe as the destination. For example, when completing the order or payment through communication with the server 10, the vehicle 100 may additionally control the navigation device 104 to set the stopover or the route guidance to the specific cafe as the destination.

When the vehicle 100 is driving according to the route guidance of the navigation device 104, when the position of the vehicle 100 is located in a place separated by a specified distance from the specific cafe, or when a specified time remains until arriving at the specific café, or when entering the specific cafe, the vehicle 100 may receive background music provided at the specific cafe from the server 10 of the specific cafe.

The vehicle 100 may output the background music of the specific cafe received from the server 10 through the speaker 108. Accordingly, the vehicle 100 may allow the passengers to feel the atmosphere similar to when drinking coffee at the specific cafe while listening to the background music provided at the specific cafe.

The vehicle 100 may additionally receive lighting information related to the specific cafe from the server 10 and control the lighting device 112 in the vehicle 100 to correspond to the lighting information related to the specific cafe. For example, when the vehicle 100 enters the specific cafe, when the lighting device 112 in the vehicle 100 is controlled, the passengers may know that they are entering the specific cafe.

Furthermore, in addition to the above-described embodiment, when the vehicle 100 is requested to control a limited vehicle by a protocol previously negotiated between the manufacturer of the vehicle 100 and the service provider of the server 10, the vehicle 100 may allow the control of the server 10 only when there is no problem after matching with the predetermined condition according to the state information related to the current vehicle 100 only for the negotiated control operation (or also referred to as the function).

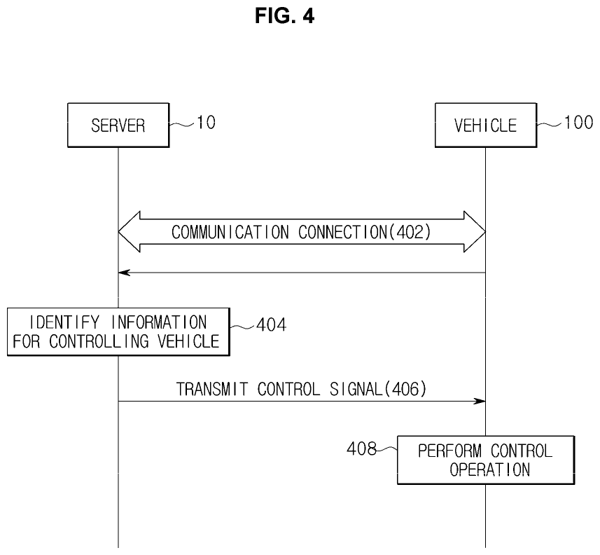

FIG. 4 is a flowchart illustrating an operation of a system including a server and a vehicle according to various exemplary embodiments of the present invention.

The server 10 and the vehicle 100 may be connected to each other by communication (402).

For example, the vehicle 100 may be communicatively connected to the server 10 according to the user manipulation through the input/output device.

As various exemplary embodiments of the present invention, when the vehicle 100 enters a predetermined position, the vehicle 100 may be communicatively connected to the server 10.

The server 10 may identify information for controlling the vehicle 100 based on the communication connection between the server 10 and the vehicle 100 (404).

The server 10 (or the controller 16 of the server 10) may transmit the control signal corresponding to information for controlling the vehicle 100 to the vehicle 100 through the communicator 12 (406).

The vehicle 100 (or the control device 118 of the vehicle 100) may perform the control operation based on the reception of the control signal (408).

The vehicle 100 may receive the control signal through the communication device 114, and may perform the control operation by identifying information for controlling the vehicle 100 included in the control signal.

Since it has been described in detail in the detailed embodiment of the control operation, it will be omitted.

According to the above-described embodiment of FIG. 4, based on the communication connection between the server 10 and the vehicle 100, the control operation of the vehicle 100 by the server 10 may be performed.

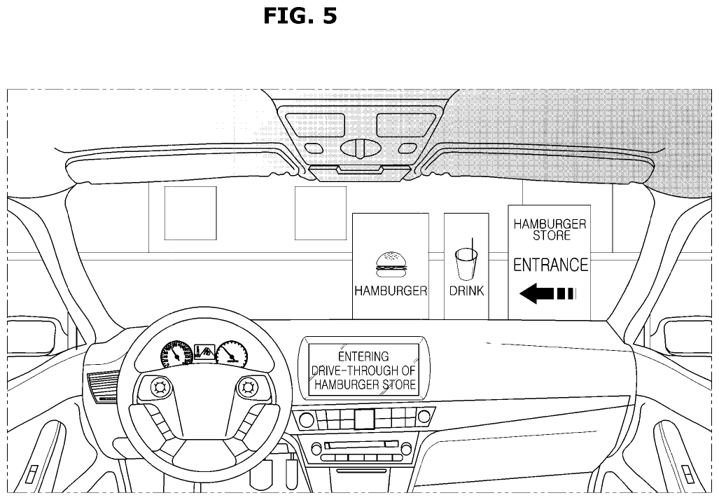

FIG. 5 is a view for describing an operation of a vehicle according to various exemplary embodiments of the present invention.

Referring to FIG. 5, when the vehicle 100 enters the drive-through of any one store, for example, a hamburger store, according to the above-described embodiment, the passenger of the vehicle 100 may have the user experience such as entering the hamburger store.

For example, when the vehicle 100 enters the drive-through of the hamburger store, the vehicle 100 may receive the control signal from the server 10 related to the hamburger store, and may control the lighting device 112, the display device 110 and/or the speaker 108 in the interior of the vehicle 100.

The vehicle 100 may control the brightness and color of the lighting device 112 of the vehicle 100 based on the lighting information included in the control signal to emit light. The lighting information may include information that enables the lighting device 112 to output a brightness and color similar to lighting in a current store.

Furthermore, the vehicle 100 may control the display device 110 of the vehicle 100 to provide the visual information corresponding to the service information according to the service information included in the control signal.

The visual information corresponding to the service information may include information such as that the vehicle 100 is entering the drive-through of the store. The visual information corresponding to the service information may be referred to as a screen associated with the service of the store, and may include information such as menu selection, benefit, event, and/or payment.

The visual information provided by the display device 110 may be sequentially changed and provided according to the predetermined order according to the driving of the vehicle 100, user manipulation, and/or the passage of time.

Furthermore, the vehicle 100 may control the speaker 108 to output the sound included in the control signal. The sound may be music currently provided in the store.

Meanwhile, as various exemplary embodiments of the present invention, the vehicle 100 may perform the control operation according to the control signal of the server 10 described above even when ordering and/or paying for some food while driving the vehicle 100.

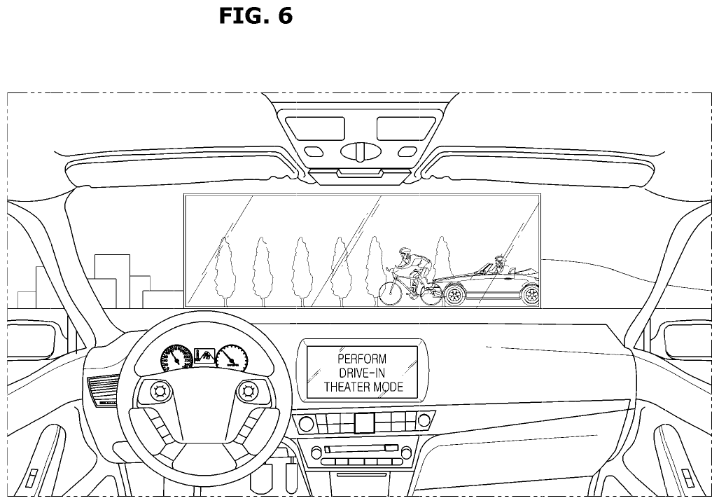

FIG. 6 is a view for describing an operation of a vehicle according to various exemplary embodiments of the present invention.

Referring to FIG. 6, when the vehicle 100 enters the drive-in theater, according to the above-described embodiment, the vehicle 100 may control the atmosphere inside the vehicle 100 to become a cinema-like atmosphere, output of mood lighting, output of a dedicated screen, and/or a dedicated mode (also called the theme).

For example, when the vehicle 100 enters the drive-in theater, the vehicle 100 may control the lighting device 112 in the interior of the vehicle 100, the display device 110, the speaker 108, and/or other devices of the vehicle 100 through communication with the server 10 of the drive-in theater.

When entering the drive-in theater, the vehicle 100 may execute drive-in theater mode as the route guidance of the navigation device 104 is terminated.

Furthermore, the vehicle 100 may control the brightness and color of the lighting device 112 of the vehicle 100 based on the lighting information included in the control signal to emit light. The lighting information may include information configured for outputting the brightness and color that enables the lighting device 112 to generate the atmosphere such as a movie theater in the interior of the vehicle 100.

The vehicle 100 may turn off daytime running lights (DRL) through an electronic parking brake (EPB) based on the lighting information included in the control signal.

Furthermore, the vehicle 100 may control the display device 110 of the vehicle 100 to provide the visual information corresponding to the service information according to the service information included in the control signal.

The visual information corresponding to the service information may include information such as that the vehicle 100 executes the drive-in theater mode.

The visual information corresponding to the service information may include information such as guidance on the parking area of the vehicle 100 and recommending an optimal seat setting suitable for the area in which the vehicle 100 is parked.

The visual information corresponding to the service information may be referred to as the screen associated with the service of the drive-in theater, and may include information such as an order menu for ordering food (drinks, popcorn, etc.) sold in the drive-in theater, movie information and/or other information, etc. By use of the food order menu, the passenger of the vehicle 100 may place the order for food, and accordingly, inconveniences such as having to go to order the food directly by the passenger may be solved.

The visual information provided by the display device 110 may be sequentially changed and provided according to the predetermined order according to the driving of the vehicle 100, user manipulation, and/or the passage of time.

Furthermore, the vehicle 100 may set the radio frequency of the vehicle 100 as the radio frequency included in the control signal. For example, after switching media to radio by controlling the AVN device of the vehicle 100, the radio frequency may be set.

Furthermore, the vehicle 100 may set the volume of the speaker 108 to the speaker volume included in the control signal.

Furthermore, the vehicle 100 may convert the power of the vehicle 100 to an accessory mode (ACC) in which electric devices of the vehicle 100 may be used without an engine operation.

The vehicle and the method of controlling the vehicle according to an aspect may utilize the vehicle as a service space rather than a moving space, and allow the passenger of the vehicle to experience various types of service.

For example, the vehicle and the method of controlling the vehicle may allow the passenger to experience various types of service by use of a combination of devices in the vehicle through communication with an external server. Accordingly, it is possible to satisfy the demand for the passenger of the vehicle to use the services of some stores without getting off the vehicle.

The vehicle and the method of controlling the vehicle may allow the passengers to receive services that are flexibly provided according to a concept of the service provider.

For example, the vehicle may receive different music or lighting information from the server of the service provider according to time and/or season, in addition to the driving mode and sound setting of the vehicle. Furthermore, the services may be provided from the server of the service provider while changing various services for each vehicle.

For example, to receive the service, the vehicle may receive may receive the service according to a service provision standard which is variably changed from the server of the service provider according to an arrival time of a predetermined place, an order time of the service, the position of the vehicle, or a use time of a basic service.

For example, depending on an agreement between a vehicle manufacturer and the service provider, a service type of the service provider, etc., an actual order may be received at the server at the moment when beverage and/or food is ordered in advance or 10 minutes before arrival at a predetermined place, and the lighting device and music of the vehicle may be controlled based on the control of the server. Furthermore, a condition at which control by the server is terminated may be variously changed, such as when 30 minutes elapse after the beverage is picked up at the moment when the vehicle leaves a parking lot of the predetermined place, or the vehicle enters another mode.

The vehicle and the method of controlling the vehicle according to an aspect may be applied to a shared vehicle, a purpose built vehicle (PBV), and the like so that it may be extended to spatial services such as various types of mobile services.

The disclosed exemplary embodiments may be implemented in a form of a recording medium storing computer-executable instructions that are executable by a processor. The instructions may be stored in a form of a program code, and when executed by a processor, the instructions may generate a program module to perform operations of the included exemplary embodiments. The recording medium may be implemented non-transitory as a non-transitory computer-readable recording medium.

The non-transitory computer-readable recording medium may include all types of recording media storing commands which may be interpreted by a computer. For example, the non-transitory computer-readable recording medium may be, for example, ROM, RAM, a magnetic tape, a magnetic disc, flash memory, an optical data storage device, and the like.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A vehicle comprising:
a communication device;
an output device; and
a control device electrically connected to the communication device and the output device,
wherein the control device is configured to:
receive a control signal for controlling at least one operation of the output device from a server through the communication device according to at least one of a position of the vehicle, communication with an external device of the vehicle, and a current time, and
control the at least one operation of the output device according to the control signal.

2. The vehicle according to claim 1, wherein the control device is configured to:
transmit a service request signal to the server through the communication device according to at least one of the position of the vehicle, the communication with the external device of the vehicle, and the current time, and
receive the control signal through the communication device in a response to the transmission of the service request signal.

3. The vehicle according to claim 1, wherein the control device is configured to receive the control signal through the communication device according to a communication connection with the server.

4. The vehicle according to claim 1, further including:
a navigation device engaged to the control device,
wherein the control device is configured to receive the control signal from the server on a basis that the position of the vehicle is a position corresponding to a predetermined reference distance to a destination or a stopover set by the navigation device.

5. The vehicle according to claim 1, further including:
a navigation device engaged to the control device,
wherein the control device is configured to receive the control signal from the server on the basis that the current time corresponds to a predetermined reference time required with an expected arrival time to a destination or a stopover set by the navigation device.

6. The vehicle according to claim 1, further including:
a navigation device engaged to the control device,
wherein the control device is configured to receive the control signal from the server in a response to an end of a route guidance of the navigation device according to the position of the vehicle being a destination or a stopover set by the navigation device of the vehicle.

7. The vehicle according to claim 1, wherein the control device is configured to receive the control signal from the server according to communication with the external device for at least one of order and payment.

8. The vehicle according to claim 7, further including:
a navigation device engaged to the control device,
wherein, according to at least one of the order and the payment, the control device is configured to control the navigation device to guide the vehicle to a route including a service provider related to the at least one of the order and the payment.

9. The vehicle according to claim 1, wherein the control device is configured to receive the control signal from the server according to the position of the vehicle being a predetermined place related to the server.

10. The vehicle according to claim 1, wherein the control device is configured to receive the control signal from the server based on the vehicle being stopped.

11. The vehicle according to claim 1,
wherein the output device includes a speaker; and
wherein the control device is configured to control the speaker to output a sound included in the control signal.

12. The vehicle according to claim 1,
wherein the output device includes at least one lighting device; and
wherein the control device is configured to control the at least one lighting device to output light of brightness and color corresponding to lighting information according to the lighting information included in the control signal.

13. The vehicle according to claim 1,
wherein the output device includes a display device; and
wherein the control device is configured to control the display device to provide visual information corresponding to service information according to the service information included in the control signal.

14. The vehicle according to claim 1,
wherein the output device includes a speaker; and
wherein the control device is configured to set a radio frequency of the vehicle and control a volume of the speaker according to radio frequency information and volume information related to the speaker included in the control signal.

15. The vehicle according to claim 13,
wherein the output device includes at least one of a speaker or the display device; and
wherein the control device is configured to control the output device to output information for guiding a parking area and information for recommending seat setting of the vehicle according to the information for guiding the parking area of the vehicle and the information for recommending seat setting of the vehicle included in the control signal.

16. A method of controlling a vehicle, the method comprising:
receiving, by a control device, a control signal for controlling at least one operation of an output device from a server through a communication device according to at least one of a position of the vehicle, communication with an external device of the vehicle, and a current time; and
controlling, by the control device, the at least one operation of the output device according to the control signal.

17. The method according to claim 16, wherein the controlling of the at least one operation includes:
controlling a speaker included in the output device to output a sound included in the control signal.

18. The method according to claim 16, wherein the controlling of the at least one operation includes:
controlling at least one lighting device included in the output device to output light of brightness and color corresponding to lighting information according to the lighting information included in the control signal.

19. The method according to claim 16, wherein the controlling of the at least one operation includes:
controlling a display device included in the output device to provide visual information corresponding to service information according to the service information included in the control signal.

20. The method according to claim 16, wherein the controlling of the at least one operation includes:
setting a radio frequency of the vehicle and controlling a volume of a speaker according to radio frequency information included in the control signal and volume information related to the speaker included in the output device.
